(19) United States
(12) Patent Application Publication
(10) Pub. No.: US 2017/0006480 A1
(43) Pub. Date: Jan. 5, 2017

(54) HETEROGENEOUS MULTI-USER GROUPS FOR WIRELESS COMMUNICATIONS

(71) Applicant: QUALCOMM Incorporated, San Diego, CA (US)

(72) Inventors: Xiaolong Huang, Morgan Hill, CA (US); Srinivas Katar, Fremont, CA (US); Chao Zou, San Jose, CA (US)

(21) Appl. No.: 14/872,856

(22) Filed: Oct. 1, 2015

Related U.S. Application Data
(60) Provisional application No. 62/187,740, filed on Jul. 1, 2015.

(51) Int. Cl. H04W 24/02; H04W 52/26

(52) U.S. Cl. CPC H04W 24/02; H04W 52/267

(57) ABSTRACT

Methods, systems, and devices are described for wireless communications. An access point (AP) communicates to a multi-user (MU) group of stations (STAs) that are assigned disparate modulation and coding schemes (MCSs). The AP sends an MU transmission to the MU group using an MCS and transmit power combination that is associated with the highest estimated throughput. The AP selects the MCS and transmit power combination from two configurations. In the first configuration, a single MCS and corresponding transmit power is used for the MU transmission. In the second configuration, a single transmit power and two different MCSs are used for the MU transmission. Both configurations may use the MCSs associated with the STAs in the MU group. The transmit power may correspond to one of the selected MCSs.

### CROSS REFERENCES

The present application for patent claims priority to U.S. Provisional Patent Application No. 62/187,740 by Huang et al., entitled “Heterogeneous Multi-User Groups for Wireless Communications,” filed Jul. 1, 2015, assigned to the assignee hereof, and expressly incorporated by reference herein.

### BACKGROUND

Field of the Disclosure

The following relates generally to wireless communication, for example heterogeneous multi-user (MU) group communications.

Description of Related Art

Wireless communications systems are widely deployed to provide various types of communication content such as voice, video, packet data, messaging, broadcast, and so on. These systems are often multiple-access systems capable of supporting communication with multiple users by sharing the available system resources (e.g., time, frequency, and power).

A Wireless Local Area Network (WLAN), such as a Wi-Fi (IEEE 802.11) network, usually includes an access point (AP) that simultaneously supports communications for multiple stations (STAs) or mobile devices. In some cases, an AP simultaneously communicates with more than one STA using a multi-user (MU) transmission. The AP can concurrently send traffic to multiple STAs in an MU group in a downlink transmission and receive traffic from multiple STAs in an MU group in an uplink transmission. MU groups are traditionally formed from a set of STAs having the same modulation and coding scheme (MCS). Yet in some cases, the AP can have data queued for transmission to a STA with a different MCS from the MCSs of other STAs connected to the AP. Under these circumstances, the AP transmits to the STA using a less-efficient single-user (SU) transmission, which decreases overall network throughput.

### SUMMARY

The present description discloses techniques for performing heterogeneous or mixed-MCS MU communications in a WLAN. According to these techniques, an AP selects STAs with disparate MCSs for an MU group. The AP selects an MCS and transmit power combination for the STAs in the MU group during the MU transmission by evaluating a number of predefined MU transmission configurations. For example, the AP compares the expected throughput of a) a first MU transmission configuration in which the AP transmits to both STAs using a common MCS for each station and a transmit power corresponding to the common MCS, and b) a second MU transmission configuration in which the AP transmits to the STAs using different MCSs at a transmit power corresponding to the MCS of a secondary STA in the MU group. The AP then selects the MU transmission configuration providing the highest expected throughput for the MU transmission.

The present description also discloses techniques for heterogeneous access category (AC) MU communications in a WLAN. According to these techniques, an AP detects a backlog in traffic for an AC and includes data associated with that AC in an MU transmission having primary traffic corresponding to a different AC.

A method of wireless communication at a wireless device includes forming an MU group comprising a primary station associated with a first MCS and a secondary station associated with a second MCS, wherein the second MCS is different from the first MCS; and estimating a throughput for at least one MU transmission configuration from the group consisting of a first MU transmission configuration and a second MU transmission configuration. The first MU transmission configuration uses a common MCS for the primary station and the secondary station and a transmit power corresponding to the common MCS. The common MCS is selected from the group consisting of the first MCS and the second MCS. The second MU transmission configuration uses the first MCS for the primary station and the second MCS for the secondary station, and the primary station and the secondary station use a transmit power corresponding to the second MCS. The method also includes transmitting to the MU group according to one of the MU transmission configurations based at least in part on the estimated throughput for the MU transmission configurations.

A communication device includes an MU group selector to form an MU group comprising a primary station associated with a first MCS and a secondary station associated with a second MCS, wherein the second MCS is different from the first MCS; and a throughput estimator to estimate a throughput for at least one MU transmission configuration from the group consisting of a first MU transmission configuration and a second MU transmission configuration. The first MU transmission configuration uses a common MCS for the primary station and the secondary station and a transmit power corresponding to the common MCS. The common MCS is selected from the group consisting of the first MCS and the second MCS. The second MU transmission configuration uses the first MCS for the primary station and the second MCS for the secondary station, and the primary station and the secondary station use a transmit power corresponding to the second MCS. The communication device also includes an MU transmission generator to transmit to the MU group according to one of the MU transmission configurations based at least in part on the estimated throughput for the MU transmission configurations.

Another communication device includes means for forming a multi-user (MU) group comprising a primary station associated with a first modulation and coding scheme (MCS) and a secondary station associated with a second MCS, wherein the second MCS is different from the first MCS; and means for estimating a throughput for at least one MU transmission configuration from the group consisting of a first MU transmission configuration and a second MU transmission configuration. The first MU transmission configuration uses a common MCS for the primary station and the secondary station and a transmit power corresponding to the common MCS. The common MCS is selected from the group consisting of the first MCS and the second MCS. The second MU transmission configuration uses the first MCS for the primary station and the second MCS for the secondary station, and the primary station and the secondary station use a transmit power corresponding to the second MCS. The communication device also includes means for transmitting to the MU group according to one of the MU transmission configurations based at least in part on the estimated throughput for the MU transmission configurations.

A non-transitory computer-readable medium storing code for wireless communication at a wireless device is described. The code includes instructions executable to cause a communication device to form a multi-user (MU) group comprising a primary station associated with a first modulation and coding scheme (MCS) and a secondary station associated with a second MCS, wherein the second MCS is different from the first MCS; and estimate a throughput for at least one MU transmission configuration from the group consisting of a first MU transmission configuration and a second MU transmission configuration. The first MU transmission configuration uses a common MCS for the primary station and the secondary station and a transmit power corresponding to the common MCS. The common MCS is selected from the group consisting of the first MCS and the second MCS. The second MU transmission configuration uses the first MCS for the primary station and the second MCS for the secondary station, and the primary station and the secondary station use a transmit power corresponding to the second MCS. The code is also executable to cause the communication device to transmit to the MU group according to one of the MU transmission configurations based at least in part on the estimated throughput for the MU transmission configurations.

Estimating the throughput can include determining that a difference between a first transmit power corresponding to the first MCS and the transmit power corresponding to the second MCS satisfies a threshold. In such a case, transmitting to the MU group includes selecting the first MU transmission configuration for the transmission based at least in part on the determination. Estimating the throughput can include determining that a difference between a first transmit power corresponding to the first MCS and the transmit power corresponding to the second MCS does not satisfy a threshold. In such a case, transmitting to the MU group includes selecting the second MU transmission configuration for the transmission based at least in part on the determination.

Some examples of the method, communication devices, or non-transitory computer-readable medium described above include determining channel conditions for a channel associated with the primary station and the secondary station. In such cases, estimating the throughput is based at least in part on the channel conditions. In some examples, transmitting to the MU group includes selecting one of the MU transmission configurations having a highest estimated throughput. Additionally or alternatively, some examples include determining a nominal signal-to-noise ratio (SNR) associated with each of the first MCS and the second MCS. In such cases, estimating the throughput is based at least in part on the nominal SNRs.

The common MCS can be associated with a highest transmit power between the first transmit power and the second transmit power. The first MCS is selected as the common MCS for the first MU transmission configuration if the first MCS is lower than the second MCS, and the second MCS is selected as the common MCS for the first MU transmission configuration if the first MCS is higher than the second MCS. In some examples, forming the MU group comprising the primary station and the secondary station is based at least in part on a determination that each station in a basic service set (BSS) is associated with a different MCS than the primary station.

Some examples of the method, communication devices, or non-transitory computer-readable medium described above include identifying the secondary station as having a highest MCS compared to each station in the BSS that is a candidate for MU grouping with the primary station, and selecting the secondary station for the MU group with the primary station. The transmit power corresponding to the second MCS and the transmit power corresponding to the first MCS can be different.

A method of wireless communication at a wireless device includes detecting a backlog condition for a first AC of traffic; forming an MU group comprising a first station associated with pending data of the first AC and a second station associated with pending data of a second AC, wherein the first AC and the second AC are different and the MU group is formed based at least in part on the detected backlog condition for the first AC; and transmitting the pending data of the first AC and the pending data of the second AC concurrently to the MU group.

A communication device includes an access category (AC) backlog detector to detect a backlog condition for a first AC of traffic, an MU group selector to form an MU group comprising a first station associated with pending data of the first AC and a second station associated with pending data of a second AC, wherein the first AC and the second AC are different and the MU group is formed based at least in part on the detected backlog condition for the first AC; and an MU transmission generator to transmit the pending data of the first AC and the pending data of the second AC concurrently to the MU group.

Another communication device includes means for detecting a backlog condition for a first AC of traffic; means for forming an MU group comprising a first station associated with pending data of the first AC and a second station associated with pending data of a second AC, wherein the first AC and the second AC are different and the MU group is formed based at least in part on the detected backlog condition for the first AC; and means for transmitting the pending data of the first AC and the pending data of the second AC concurrently to the MU group.

A non-transitory computer-readable medium storing code for wireless communication at a wireless device is described. The code includes instructions executable to cause a communication device to detect a backlog condition for a first AC of traffic; form an MU group comprising a first station associated with pending data of the first AC and a second station associated with pending data of a second AC, wherein the first AC and the second AC are different and the MU group is formed based at least in part on the detected backlog condition for the first AC; and transmit the pending data of the first AC and the pending data of the second AC concurrently to the MU group.

Detecting the backlog condition can include determining a quality of service associated with the first AC is not satisfied. In some cases, the first AC is associated with a higher priority than the second AC. A second backlog condition can be detected for a third AC, in which case selecting the first AC for inclusion in the MU group can be based at least in part on a determination that the backlog condition for the first AC is greater than the backlog condition for the third AC.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system that supports mixed-MCS and mixed-AC MU communications in accordance with various aspects of the present disclosure;

FIG. 2 illustrates an example of a wireless communications system that supports mixed-MCS MU communications in accordance with various aspects of the present disclosure;

FIG. 3 shows a process flow that illustrates one example of mixed-MCS MU communications in a wireless communication system, in accordance with various aspects of the present disclosure;

FIG. 4 illustrates an example of a wireless communications system that supports mixed-AC MU communications in accordance with various aspects of the present disclosure;

FIG. 5 shows an wireless communications system that supports mixed-AC communications in accordance with various aspects of the present disclosure;

FIG. 6A shows a block diagram of an example AP that supports mixed-MCS MU communications in accordance with various aspects of the present disclosure;

FIG. 6B shows a block diagram of an example AP that supports mixed-MCS MU communications in accordance with various aspects of the present disclosure;

FIG. 7 shows a flow chart that illustrates one example of a method for wireless communication, in accordance with various aspects of the present disclosure; and

FIG. 8 shows a flow chart that illustrates one example of a method for wireless communication, in accordance with various aspects of the present disclosure.

### DETAILED DESCRIPTION

According to principles of this disclosure, a communication device such as an access point (AP) forms a multi-user (MU) group from stations (STAs) associated with disparate modulation and coding schemes (MCSs). One of the STAs is designated as a primary STA and another STA (e.g., a candidate STA having the highest MCS) is designated as a secondary STA for the MU transmission. After selecting the STAs for the MU group, the AP selects one of two predefined MU transmission configurations for the MU transmission. In the first MU transmission configuration, the same MCS and transmit power are used for each STA. In the second MU transmission configuration, the STAs retain different MCSs and a single transmit power corresponding to the MCS of the secondary STA is used. The AP selects the MU transmission configuration that provides the highest estimated throughput and sends an MU transmission to the STAs in the MU group according to the selected MU transmission configuration.

The AP can also form an MU group that includes STAs associated with different traffic access categories (ACs). For example, when the AP has data to transmit to a primary STA, the AP selects a partner or secondary STA to be in an MU group with the primary STA based at least in part on a determination that the secondary STA is associated with traffic for a backlogged or underserved AC.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

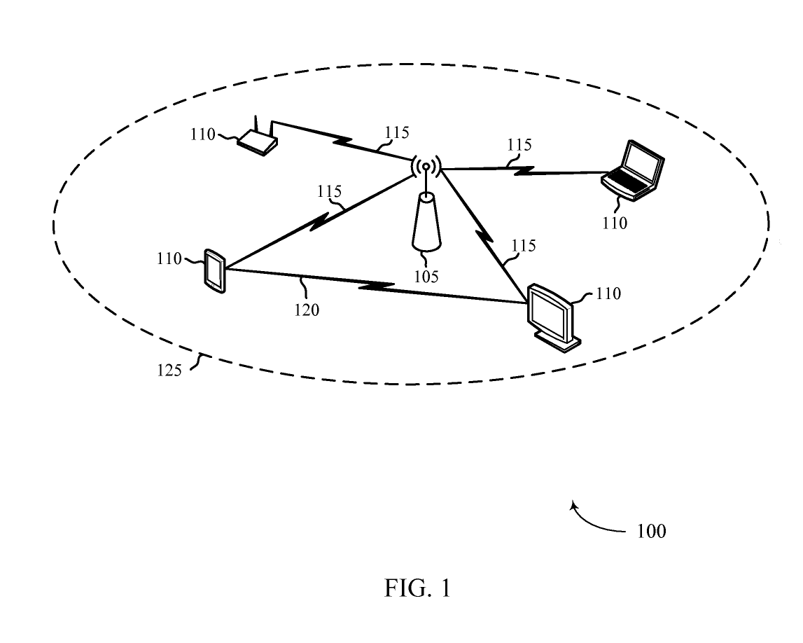

FIG. 1 illustrates an example of a wireless communications system 100 that supports mixed-MCS and mixed-AC MU communications in accordance with various aspects of the present disclosure. Heterogeneous or mixed-MCS MU communications refer to MU communications that involve STAs 110 which are assigned disparate MCSs immediately prior to the MU grouping. The wireless communications system 100 is a WLAN including an access point (AP) 105 and multiple stations (STAs) 110, which can be mobile stations, smartphones, tablets, laptops, personal digital assistants (PDAs), other handheld devices, netbooks, notebook computers, display devices (e.g., TVs, computer monitors, etc.), printers, etc. The STAs 110, also referred to as mobile stations (MSs), mobile devices, access terminals (ATs), user equipment (UE), subscriber stations (SSs), or subscriber units, associate and communicate with the AP 105 via a communication link 115. The AP 105 has a geographic coverage area 125 such that STAs 110 within that area are within range of the AP 105. The STAs 110 are dispersed throughout the geographic coverage area 125. Each STA 110 may be stationary or mobile.

Although not shown in FIG. 1, a STA 110 can be covered by more than one AP 105 and can therefore associate with one or more APs 105 at different times. A single AP 105 and an associated set of STAs 110 are referred to as a basic service set (BSS). An extended service set (ESS) is a set of connected BSSs. A distribution system (DS) (not shown) is used to connect APs 105 in an ESS. A geographic coverage area 125 for an AP 105 can be divided into sectors making up only a portion of the coverage area (not shown). The wireless communications system 100 includes APs 105 of different types (e.g., metropolitan area, home network, etc.), with varying sizes of coverage areas and overlapping coverage areas for different technologies. Although not shown, other wireless devices can communicate with the AP 105.

While the STAs 110 are capable of communicating with each other through the AP 105 using communication links 115, STAs 110 can also communicate with each other via direct wireless link 120. Direct wireless communication links can occur between STAs 110 regardless of whether any of the STAs is connected to an AP 105. Examples of direct wireless links 120 include Wi-Fi Direct connections, connections established by using a Wi-Fi Tunneled Direct Link Setup (TDLS) link, and other peer-to-peer (P2P) group connections. The STAs 110 and APs 105 shown in FIG. 1 communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, 802.11z, etc.

Different modulation schemes and coding rates can be used to transmit signals between the AP 105 and a STA 110. Examples of modulation schemes include binary phase shift keying (BPSK), quadrature phase shift keying (QPSK), and quadrature amplitude modulation (QAM) (e.g., 16QAM, 64QAM, 256QAM, etc.). Coding rate may refer to a portion of an error-correcting code that adds redundant information to the signal. The coding rate is a ratio of user date bits to channel bits. The combination of modulation scheme and coding rate applied to a signal is referred to as the modulation and coding scheme (MCS). The MCS used for a transmission is identified using an index value (e.g., from 0 to 9). These index values also identify the number of spatial streams used to convey the signal. For example, a signal that has MCS 0 is modulated using binary phase shift keying (BPSK) and has a code rate of ½. An MCS with an index greater than another MCS may be referred to as a higher MCS (e.g., MCS 9 is a higher MCS than MCS 6). Each MCS has a corresponding transmit power. The AP 105 assigns each STA 110 an MCS selected based at least in part on the channel conditions and capabilities of that STA 110.

Wireless communications system 100 distinguishes between different types of traffic using traffic access categories (ACs), including voice (AC_VO), video (AC_VI), best effort (AC_BE), and background (AC_BK). Each access category is associated with a priority level and a quality of service (QoS), voice having the highest priority, followed by video, best effort, and background. AP 105 prioritizes the satisfaction of the QoS associated with high priority traffic (e.g., voice data) before the satisfaction of the QoS associated with lower priority traffic (e.g., best effort data).

Wireless communications system 100 supports multi-antenna transmission techniques including multiple-input-multiple-output (MIMO) and multi-user MIMO (MU-MIMO). A MIMO communication occurs when multiple transmitter antennas (e.g., at the AP 105) send a signal to multiple receive antennas (e.g., at a STA 110). Each transmitting antenna transmits independent data (or spatial) streams to increase diversity (e.g., spatial diversity) and the likelihood successful signal reception. In other words, MIMO techniques use multiple transmitting and receiving antennas to take advantage of multipath environments to transmit multiple data streams. For downlink MU-MIMO transmissions, the AP 105 simultaneously transmits independent data streams to multiple STAs 110. For example, in a downlink MU-N transmission, the AP 105 simultaneously transmits signals to N STAs 110, thereby aggregating individual streams for the STAs 110 into a single MU-MIMO transmission which increases network throughput.

To form a new MU group, the AP 105 assigns a number of STAs 110 to a group identifier (ID). In many cases, the AP 105 selects STAs 110 with the same MCS to form an MU group. But sometimes the AP 105 has data queued for transmission to a primary STA 110 and no other STAs with the same MCS as the primary STA 110 are available to form an MU group with the primary STA 110. In this scenario, the AP 105 groups the primary STA 110 with a partner or secondary STA 110 that has a different MCS than the primary STA 110. The secondary STA 110 can be the STA 110 with the highest MCS in the BSS that is also available to receive an MU transmission.

The AP 105 can also form MU groups according to AC. For instance, the AP 105 selects STAs 110 for an MU group based at least in part on the determination that the AP 105 has the same type of traffic (e.g., data assigned the same AC) queued for transmission to each STA 110 in the group. The AP 105 can also form MU groups according to detected backlogs in throughput associated with individual ACs. For example, if the AP 105 detects that an AC (e.g., voice) is not satisfying its associated QoS, the AP 105 forms a mixed-AC MU group so that traffic of the underserved AC is transmitted with traffic of a different AC. In some cases, MU groups are formed based on a combination of traffic backlog conditions, traffic latency, MCS, and AC.

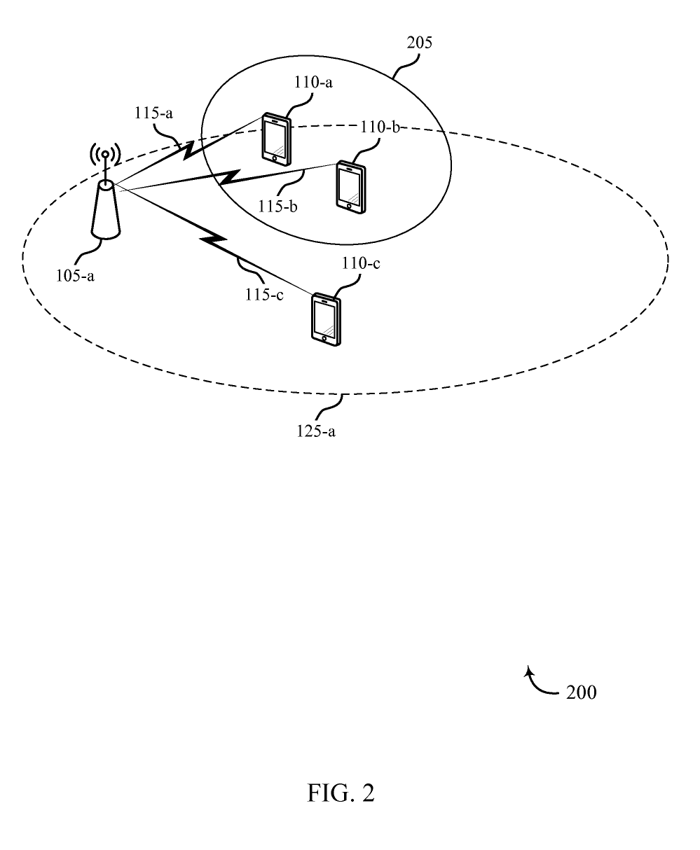

FIG. 2 illustrates an example of a wireless communications system 200 that supports MU communications for STAs assigned to different MCSs in accordance with various aspects of the present disclosure. Wireless communications system 200 includes an AP 105-a and STAs 110-a to 110-c, which implement aspects of the AP 105 and STAs 110 of the wireless communications system 100 shown in FIG. 1. AP 105-a and the STAs 110 can be part of a BSS or ESS. AP 105-a communicates (e.g., using MU transmissions) with STAs 110 within coverage area 125-a using communication links 115-a to 115-c.

AP 105-a determines that there is pending data for STA 110-a and designates STA 110-a as the primary station. AP 105-a also determines the MCSs for the STAs 110 within geographic coverage area 125-a. For example, AP 105-a identifies the MCS assigned to each of STA 110-a, STA 110-b, and STA 110-c, respectively. Upon determination of the MCSs, AP 105-a selects a partner or secondary station for inclusion in an MU group 205 with primary STA 110-a. In selecting a secondary station, AP 105-a first looks for an available STA 110 in the wireless communications system 200 having the same MCS as STA 110-a. If no available STA 110 with the same MCS as primary STA 110-a (as may happen when there are few STAs 110), AP 105-a forms a heterogeneous MU group (i.e., a mixed-MCS MU group that includes STAs 110 assigned different MCSs immediately before the grouping).

In the example of FIG. 2, none of the STAs 110 within coverage area 125-a are assigned the same MCS as primary STA 110-a. Thus, AP 105-a forms a mixed-MCS MU group 205 by pairing primary STA 110-a with secondary STA 110-b. AP 105-a selects STA 110-b as the secondary station by comparing the MCSs for each possible secondary STA 110 connected to AP 105-a and choosing the STA 110 that is currently assigned the highest MCS. For example, if STA 110-b is assigned MCS 8 and STA 110-c is assigned MCS 6, STA 110-b is selected for the mixed-MCS MU group 205. Because higher MCSs generally correspond to higher data rates, a policy of selecting the STA 110 with the highest MCS as a secondary station in the mixed-MCS MU group 205 increases overall system efficiency and/or throughput. Although described in terms of a two STAs 110, the techniques described herein can be implemented for MU groups that include any number of stations.

After forming the mixed-MCS MU group 205, AP 105-a selects an MCS and transmit power combination for an MU transmission to the mixed-MCS MU group 205. The MU transmission includes simultaneous transmissions to STA 110-a and STA 110-b (e.g., over communication links 115-a and 115-b). In some cases, a single MCS is used for the MU transmission; alternatively, separate MCSs are used to transmit to each STA 110 in the mixed-MCS MU group 205. The combination of MCS(s) and transmit power used for an MU transmission is referred to as the MU transmission configuration. AP 105-a estimates the theoretical throughput for each candidate MU transmission configuration and selects the MU transmission configuration associated with the highest expected throughput for the MU transmission.

Even though various additional possible combinations of MCS and transmit power exist, the AP 105-a selects between two predetermined MU transmission configurations. That is, AP 105-a refrains from evaluating every possible combination of MCS(s) and transmit power and instead focuses on the two MU transmission configurations that are most likely to provide the best throughput for the MU transmission. By reducing the number of MU transmission configurations considered for the MU transmission, AP 105-a conserves processing resources and reduces power consumption.

The first MU transmission configuration that AP 105-a evaluates involves the use of a single MCS and corresponding transmit power for both STAs 110 in the MU transmission. This common MCS is chosen from the set of MCSs currently assigned to the STAs of the MU group 205; thus, in this example, the common MCS is either the MCS currently assigned to STA 110-a or the MCS currently assigned to STA 110-b. Although the same MCS is used for the MU transmission, the MU transmission is still considered to be a mixed-MCS MU transmission because the STAs 110 involved in the MU group 205 are still assigned different MCSs for single user (SU) transmissions or other MU groups.

In many cases, if primary STA 110-a has an MCS (e.g., MCS 5) that is lower than the MCS assigned to secondary STA 110-b (e.g., MCS 8), AP 105-a selects the MCS of primary STA 110-a (e.g., MCS 5) as the common MCS for the first MU transmission configuration. On the other hand, if the primary STA 110-a has an MCS (e.g., MCS 5) that is higher than the MCS assigned to secondary STA 110-b (e.g., MCS 2), AP 105-a selects the MCS of the secondary STA 110-b as the common MCS for the first MU transmission configuration. The transmit power for the MU transmission in the first MU transmission configuration corresponds to the common MCS. Thus, AP 105-a selects the lowest MCS associated with the mixed-MCS MU group 205 as the common MCS. Put another way, the MCS associated with the highest transmit power is selected as the common MCS (because the transmit power associated with an MCS is inversely related to the MCS level).

For the second MU transmission configuration evaluated by AP 105-a, each STA 110-a, 110-b in the MU group 205 keeps its assigned MCS and a single transmit power is selected for the MU transmission. The transmit power corresponding to the MCS used by the secondary STA 110-b is selected as the common transmit power for the second MU transmission configuration.

AP 105-a evaluates both MU transmission configurations to determine which has the higher theoretical system throughput given the makeup of the MU group 205. The determination of throughput is based at least in part on the MCSs and transmit power associated with each configuration, as applied to observed channel conditions. The performance of a transmission may be negatively impacted if the transmit power used for the transmission does not correspond to the optimal transmit power of the MCS used for the transmission. In some cases, using a transmit power greater than the optimal transmit power for an MCS increases the error of a transmission (e.g., by introducing signal distortion). In other examples, throughput is decreased by using a transmit power that is less than the optimal power for an MCS. Decreases in performance are proportional to the discrepancy between the optimal transmit power and the chosen transmit power; that is, greater discrepancies result in greater performance loss. Thus, AP 105-a can estimate throughput for an MU transmission configuration by determining the difference between the optimal transmit power for an MCS used in the MU transmission and the actual transmit power of the MU transmission configuration.

AP 105-a can use a rule of thumb to select the MU transmission configuration with the highest theoretical throughput while conserving processing resources. Under the rule of thumb, the AP 105-a compares the transmit powers corresponding to the different MCS indices assigned to the STAs 110 in the mixed-MCS MU group 205. If the difference between the transmit powers exceeds a threshold amount, AP 105-a selects the first MU transmission configuration, which uses an optimal transmit power for a common MCS, thereby increasing throughput. Alternatively, if the difference between the MCS levels does not exceed the threshold, AP 105-a selects the second MU transmission configuration which uses a sub-optimal transmit power for the primary station (because the sub-optimal transmit power is close to the optimal transmit power). Although the second MU transmission configuration uses a sub-optimal transmit power for the primary station, the loss in throughput is compensated by each station using its optimal MCS and corresponding data rate (i.e., each STA 110 may retain its optimal MCS and refrain from down-grading to a lower common MCS).

AP 105-a is also capable of leveraging information about the communication environment (e.g., channel conditions) to determine the theoretical throughput for each MU transmission configuration. For example, AP 105-a can make measurements to determine the conditions of an MU channel (e.g., AP 105-a may determine the MU channel type) from which AP 105-a determines the nominal signal-to-noise ratio (SNR) for each MCS associated with the mixed-MCS MU group 205. Using this information, AP 105-a calculates the expected throughput for each MU transmission configuration and selects the MU transmission configuration having the highest expected throughput.

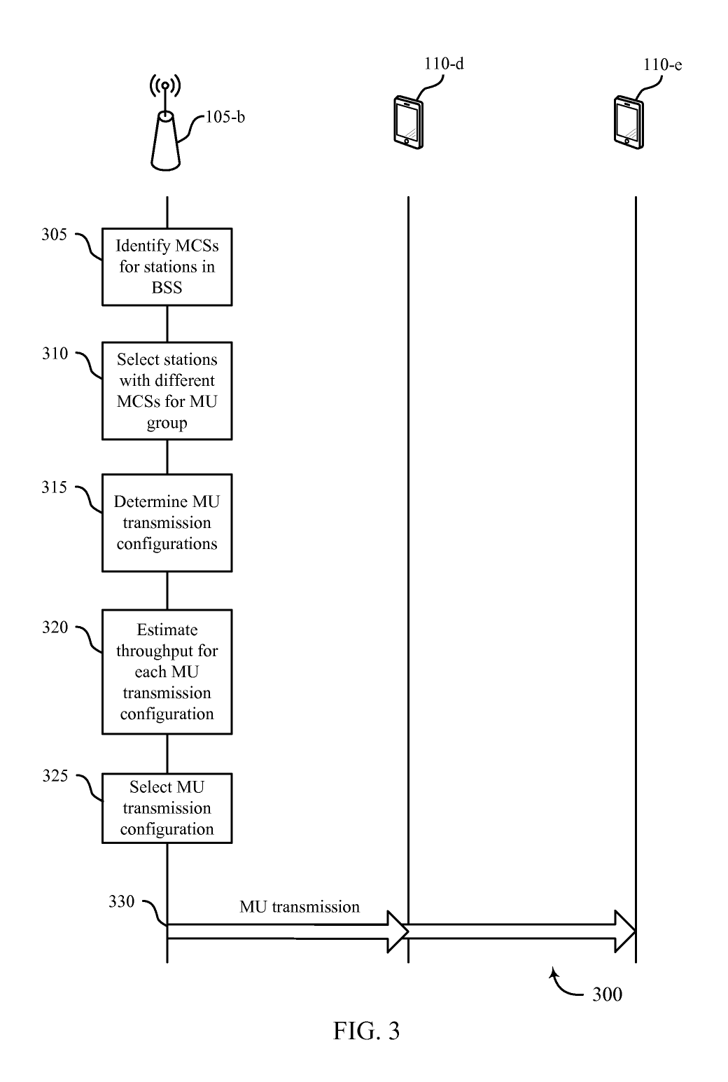

FIG. 3 shows a process flow that illustrates one example of mixed-MCS MU communications in a wireless communications system 300 that includes AP 105-b, STA 110-d, and STA 110-e. STA 110-d, STA 110-e, and AP 105-b are respective examples of the STAs 110 and APs 105 described above with reference to FIGS. 1-2. The wireless communications system 300 implements a BSS, and is an example of the wireless communications systems 100, 200 of FIGS. 1-2. In this process flow, AP 105-b selects an MU transmission configuration for communication with a mixed-MCS MU group.

At 305, AP 105-b identifies the MCSs associated with the stations in the BSS. For example, the MCSs of STA 110-d and STA 110-e (and other stations not shown) are determined. In the example, the MCSs of the stations within the BSS are different from the MCS of STA 110-d, which is the primary station. At 310, AP 105-b selects stations with different MCSs for a heterogeneous MU group (e.g., a mixed-MCS MU group). For example, AP 105-b selects STA 110-d as the primary station of the mixed-MCS MU group and STA 110-e as a secondary station of the mixed-MCS MU group.

Proceeding to 315, AP 105-b determines a first MU transmission configuration and a second MU transmission configuration. The configurations may be determined as described in FIG. 2. At 320, AP 105-b estimates a throughput for each MU transmission configuration. In other words, AP 105-b estimates a throughput for the first MU configuration and a throughput for the second MU transmission configuration. The throughput may be estimated using the techniques described above, or by other means known in the art.

At 325, AP 105-b selects an MU transmission configuration from the first MU transmission configuration and the second MU transmission configuration. The selection is based at least in part on the estimated throughput for each respective MU transmission configuration. For instance, AP 105-b selects the MU transmission configuration that is anticipated to provide the greatest throughput. Proceeding to 330, AP 105-b sends an MU transmission to STA 110-d and MU transmission to STA 110-e. The MU transmission is sent according to the MU transmission configuration selected at 325.

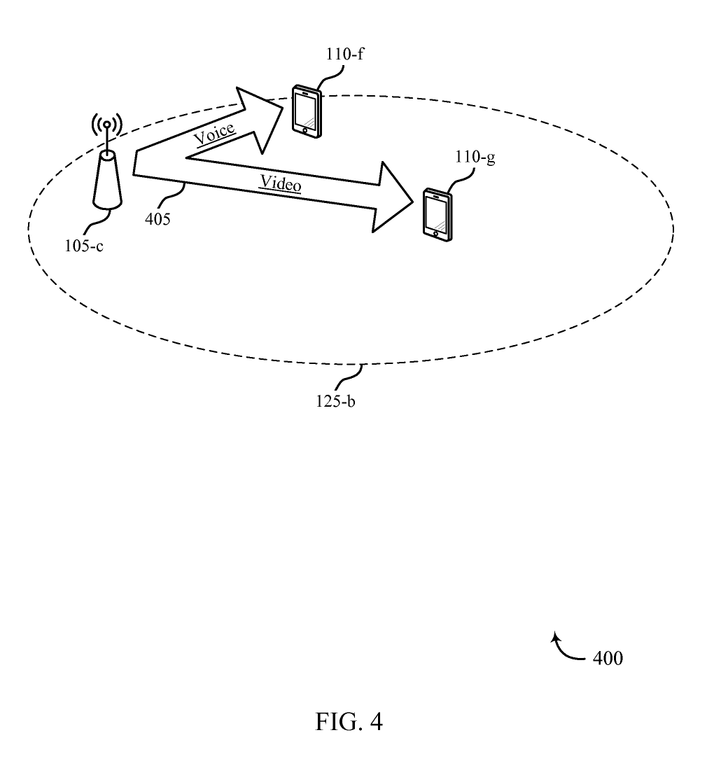

In addition to the mixed-MCS MU groups described above, the use of mixed-AC MU groups may also provide an overall increase in the system throughput and efficiency of a wireless system. A mixed-AC MU group refers to an MU group that receives an MU transmission which includes different traffic ACs. FIG. 4 illustrates an example of a wireless communications system 400 that supports mixed-AC MU communications. Wireless communications system 400 implements aspects of the wireless communications systems 100, 200, 300 of FIGS. 1-3. Wireless communications system 400 includes STA 110-f, STA 110-g, and AP 105-c. AP 105-c and the STAs 110 may be part of a BSS or ESS. AP 105-c communicates (e.g., using MU transmissions) with STAs 110 within geographic coverage area 125-b.

AP 105-c monitors the throughput of traffic associated with different ACs and detects a condition indicative of backlog for one of the ACs, such as an accumulation of traffic for the AC or an unsatisfied QoS requirement. Based at least in part on the detected backlog condition, AP 105-c forms a mixed-AC MU group. Under single-AC policies for MU transmissions, when AP 105-c has higher-priority AC data queued for transmission, an MU transmission for the higher-priority AC may preempt the transmission of data associated with a backlogged lower-priority AC. This situation may further exacerbate the backlogging of the lower-priority AC at the expense of servicing the higher-priority AC, even if the higher-priority AC is not experiencing a backlog or other QoS-related difficulties. Using a mixed-AC MU group, however, allows AP 105-c to transmit traffic associated with a backlogged lower-priority AC together with the transmission of data corresponding to higher-priority AC, which reduces the backlog of the lower-priority AC.

In this example, primary STA 110-g is the target recipient for AC traffic that is not backlogged (e.g., primary STA 110-g is the target recipient of pending video data). Before selecting a partner STA 110 to group with primary STA 110-g, AP 105-c determines if any AC has lagging throughput (i.e., is backlogged). For the purposes of this example, the AC with backlogged traffic is voice data. Thus, AP 105-c detects that voice data has backlogged traffic and determines that STA 110-f is the intended recipient of at least a portion of the voice data. Accordingly, AP 105-c selects STA 110-g as a partner station for primary STA 110-f and forms a mixed-AC MU group. AP 105-c then sends the pending video data to primary STA 110-g and the backlogged voice data to partner STA 110-f in mixed-AC MU transmission 405. Thus, an AP 105 may alleviate the backlog associated with an AC by sending multiple-AC traffic to STAs 110 in a mixed-AC MU group.

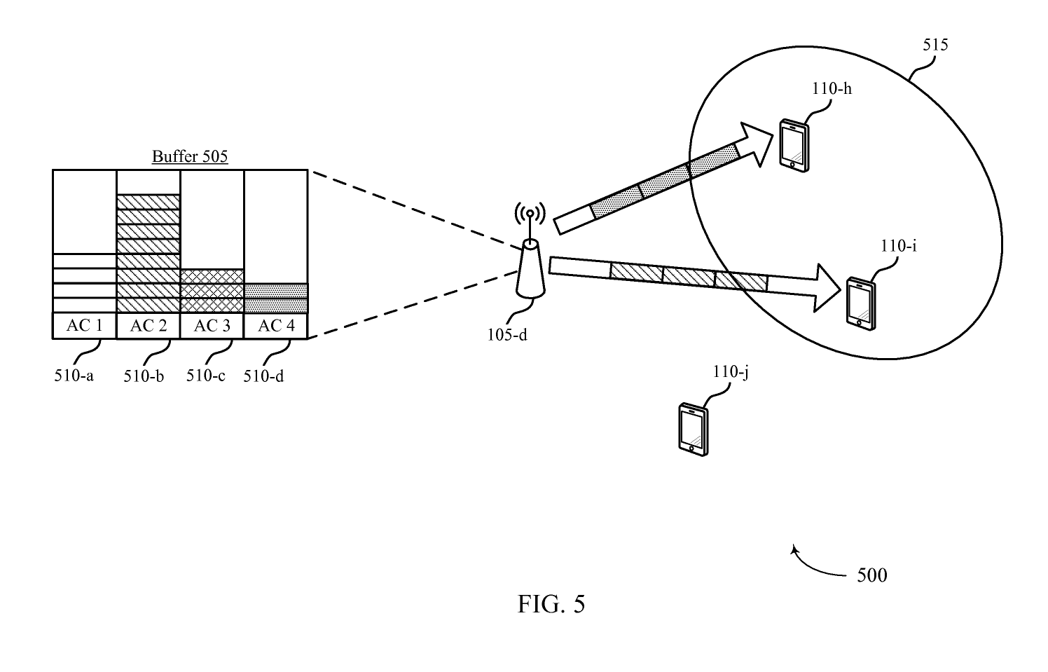

FIG. 5 shows a wireless communications system 500 that supports mixed-AC MU communications in accordance with various aspects of the present disclosure. Wireless communications system 500 includes AP 105-d, which may be part of a wireless communications systems 100 or wireless communications system 200, 400, described with reference to FIGS. 1, 2, and 4. Wireless communications system 500 also includes STA 110-h, STA 110-i, and STA 110-j, each of which may be an example of a STA 110 described with reference to FIGS. 1-4.

This example shows an illustration of an AC traffic buffer 505 internal to AP 105-d. The AC traffic buffer 505 includes a queue 510-a for a first AC (AC 1), a queue 510-b for a second AC (AC 1), a queue 510-c for a third AC (AC 3), and a queue 510-d for a fourth AC (AC 4). Each queue 510 represents the amount of pending traffic for each respective AC. Thus, AC 2 has more traffic ready for transmission than AC 1, AC 3, and AC 4. AC 1 is associated with the highest priority, followed by AC 2, AC 3, and AC 4, in that order. In the example, primary STA 110-h has pending AC 4 data, STA 110-i has pending AC 2 data, and STA 110-j has pending AC 3 data.

AP 105-d monitors the AC traffic buffer 505 and determines that AC 1 and AC 2 have backlogged traffic (e.g., by detecting an accumulation of AC 1 data in queue 510-a and an accumulation of AC 2 data in queue 510-b). In other cases, AP 105-d may reference the QoS for each AC to determine which AC is underserved. Based at least in part on the backlogged data, AP 105-d forms a mixed-AC MU group 515 that includes primary STA 110-h and the STA 110 associated with the AC with the most severe backlog condition (e.g., STA 110-i). Thus, AP 105-d selects the mixed-AC MU group 515 irrespective of the priorities associated with the backlogged AC traffic.

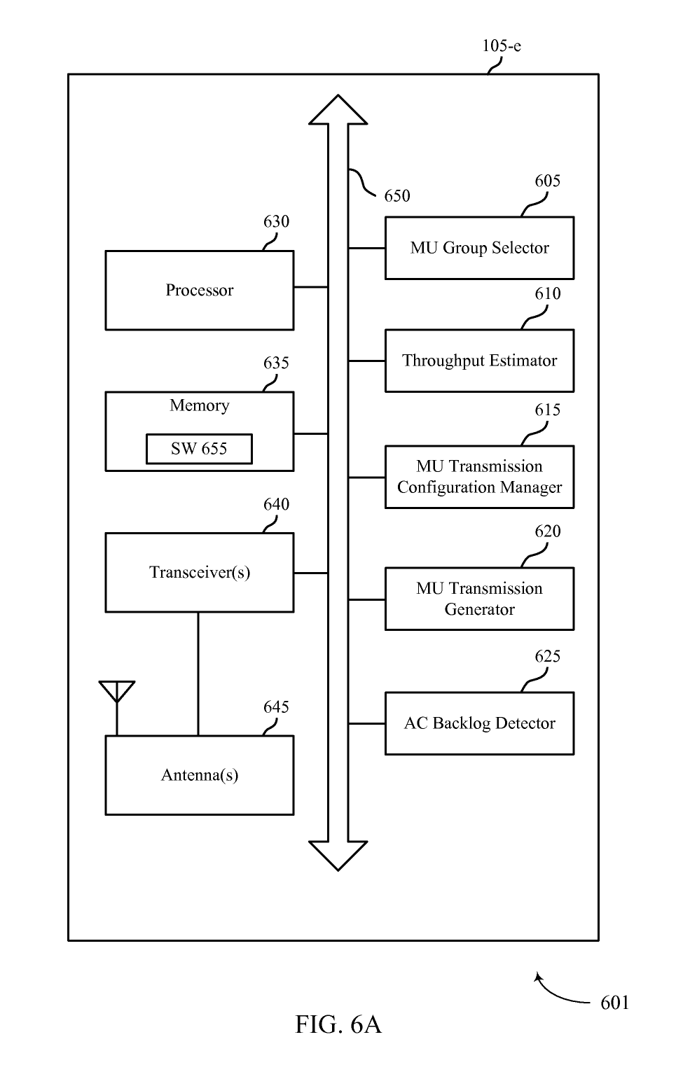

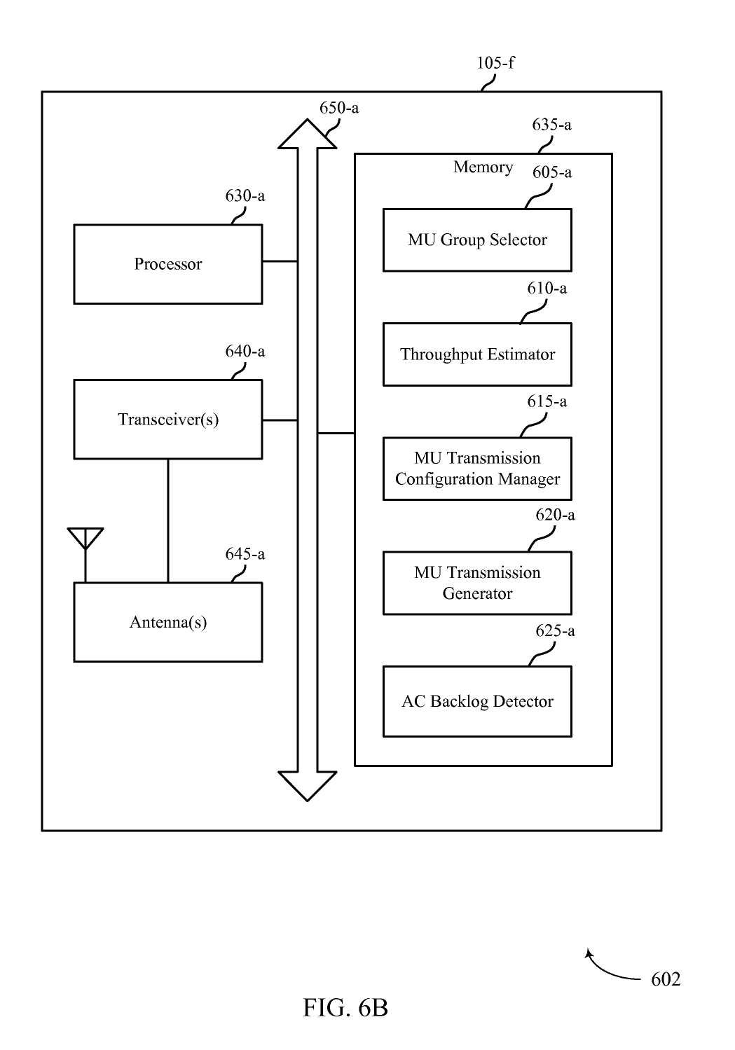

FIG. 6A shows a block diagram 601 of an example AP 105-e that supports mixed-MCS and mixed-AC MU communications in accordance with various aspects of the present disclosure, and with respect to FIGS. 1-5. AP 105-e includes a processor 630, a memory 635, one or more transceivers 640, and one or more antennas 645. AP 105-e also includes an MU group selector 605, a throughput estimator 610, an MU transmission configuration manager 615, an MU transmission generator 620, and an AC backlog detector 625. Each component of AP 105-e is communicatively coupled with a bus 650, which enables communication between the components. The antenna(s) 645 are communicatively coupled with the transceiver(s) 640.

The processor 630 is an intelligent hardware device, such as a central processing unit (CPU), a microcontroller, an application-specific integrated circuit (ASIC), etc. The processor 630 processes information received through the transceiver(s) 640 and information to be sent to the transceiver(s) 640 for transmission through the antenna(s) 645.

The memory 635 stores computer-readable, computer-executable software (SW) code 655 containing instructions that, when executed, cause the processor 630 or another one of the components of AP 105-e to perform various functions described herein, for example, determining an MU transmission configuration for mixed-MCS MU communications.

The transceiver(s) 640 communicate bi-directionally with other wireless devices, such as APs 105, STAs 110, or other devices. The transceiver(s) 640 include a modem to modulate packets and frames and provide the modulated packets to the antenna(s) 645 for transmission. The modem is additionally used to demodulate packets received from the antenna(s) 645.

The MU group selector 605, throughput estimator 610, MU transmission configuration manager 615, MU transmission generator 620, and AC backlog detector 625 implement the features described with reference to FIGS. 1-5, as further explained below.

FIG. 6A shows just one possible implementation of a device implementing the features of FIGS. 1-5. While the components of FIG. 6A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 6A may be implemented by a single, consolidated hardware block. For example, a single transceiver 640 chip may implement the processor 630, memory 635, MU group selector 605, throughput estimator 610, MU transmission configuration manager 615, MU transmission generator 620, and AC backlog detector 625.

In still other examples, the features of each component may also be implemented, in whole or in part, with instructions embodied in a memory, formatted to be executed by one or more general or application-specific processors. For example, FIG. 6B shows a block diagram 602 of another example of an AP 105-f in which the features of the MU group selector 605-a, throughput estimator 610-a, MU transmission configuration manager 615-a, MU transmission generator 620-a, and AC backlog detector 625-a are implemented as computer-readable code stored on memory 635-a and executed by one or more processors 630-a. Other combinations of hardware/software may be used to perform the features of one or more of the components of FIGS. 6A-6B. The transceiver(s) 640-a, bus 650-a, and antenna(s) 645-a may perform the functions described with reference to FIG. 6A.

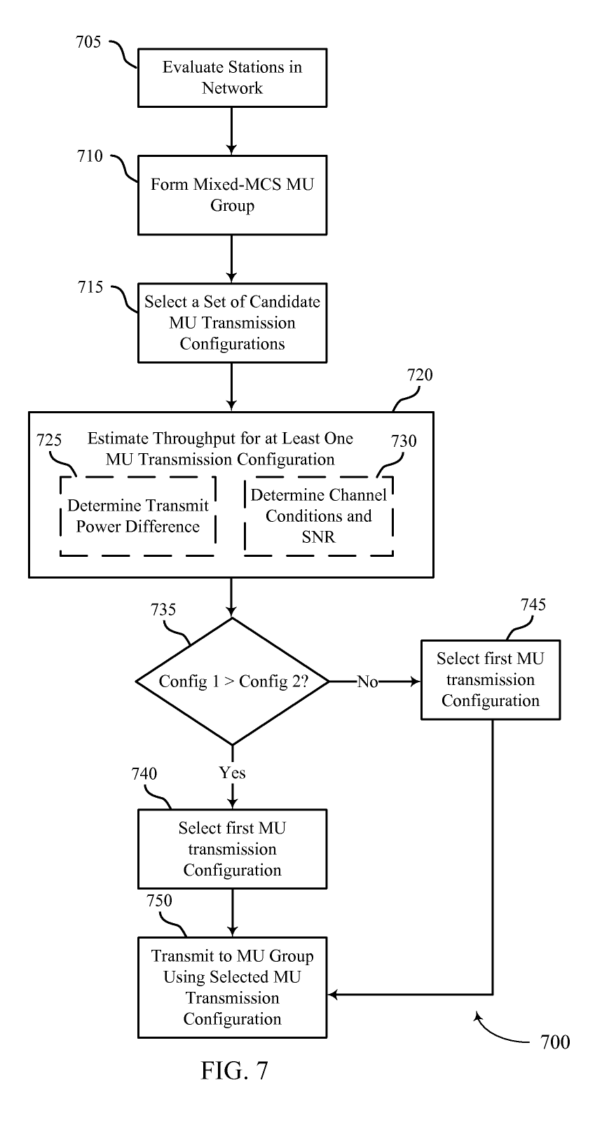

FIG. 7 shows a flow chart that illustrates one example of a method 700 for wireless communication, in accordance with various aspects of the present disclosure. The method 700 may be performed by any of the APs 105 discussed in the present disclosure, but for clarity the method 700 will be described from the perspective of the AP 105-e and AP 105-f of FIGS. 6A and 6B.

Broadly speaking, the method 700 illustrates a procedure by which the AP 105-e or 105-f forms a mixed-MCS MU group, selects an MU transmission configuration based on estimated throughput, and communicates with the MU group using the MU transmission configuration.

The method 700 begins with the AP 105-e or AP 105-f operating in a network or BSS. The AP 105-e or AP 105-f has data pending for a primary station operating according to a first MCS. At block 705, the MU group selector 605 evaluates the stations in the network. In some examples, the evaluation includes determining the MCSs associated with each station. In the present example, the stations in the network have different MCSs than the primary station. Thus, part of the evaluation may include the MU group selector 605 determining that candidate partner stations have disparate MCSs compared to the primary station. At block 710, MU group selector 605 forms a mixed-MCS MU group that includes the primary station and the station in the network identified as having the highest MCS. Thus, an MU group may be formed that includes a primary station associated with a first MCS and a partner (secondary) station associated with a second MCS. In some cases, the MU group selector 605 selects additional stations for the MU group.

Proceeding to block 715, the MU transmission configuration manager 615 selects a set of candidate MU transmission configurations. The MU transmission configuration manager 615 may also be responsible for forming the MU transmission configurations (e.g., deciding which MCS(s) and transmit power to combine). The MU transmission configurations may be composed and/or selected based at least in part on which station in the MU group has a higher MCS. In certain cases the MU transmission configuration manager 615 composes two configurations. The first MU transmission configuration uses a common MCS for the primary and partner station and a transmit power corresponding to the common MCS. The common MCS may be the first MCS (associated with the primary station) or the second MCS (associated with the partner station). In some cases, the MCS with the highest transmit power is selected as the common MCS. The second MU transmission configuration uses the first MCS for the primary station, the second MCS for the partner station, and a transmit power that corresponds to the second MCS.

At block 720, the throughput estimator 610 estimates the throughput for at least one MU transmission configuration. In some cases, the throughout estimator 610 estimates the throughput for each MU transmission configuration. In some cases, the throughput estimator 610 makes the estimation by determining, at block 725, the difference between the transmit powers associated with the MCSs of stations in the mixed-MCS MU group. For example, the throughput estimator 610 may determine that the difference between a first transmit power corresponding to the first MCS and a second transmit power corresponding to the second MCS satisfies a threshold. In some examples, the throughput estimator 610 makes the estimation by determining, at block 730, MU channel conditions and MCS SNRs, such as described with reference to FIG. 2. In some cases, the throughput estimator makes the estimation using a combination of the determined transmit power difference and the determined channel conditions and SNR.

Regardless of how the throughput for each MU transmission configuration is determined, at block 735 the throughput estimator 610 determines if the first MU transmission configuration is expected to provide greater throughput than the second MU transmission configuration. If the first MU transmission configuration is expected to provide greater throughput than the second MU transmission configuration, the MU transmission generator 620 may select, at block 740, the first MU transmission configuration as the operational configuration. In some cases, the MU transmission generator 620 may select the first MCS as the common MCS for the first MU transmission configuration if the first MCS is lower than the second MCS. In some cases, the MU transmission generator 620 may select the second MCS as the common MCS for the first MU transmission configuration if the first MCS is higher than the second MCS. If the first MU transmission configuration is not expected to provide greater throughput than the second MU transmission configuration, the MU transmission generator 620 may select, at block 745, the second MU transmission configuration as the operational configuration. Thus, the MU transmission configuration with the greatest expected throughput may be selected for MU transmissions to the mixed-MCS MU group. Accordingly, at block 750, the MU transmission generator 620 may facilitate a transmission to the mixed-MCS MU group using the selected MU transmission configuration.

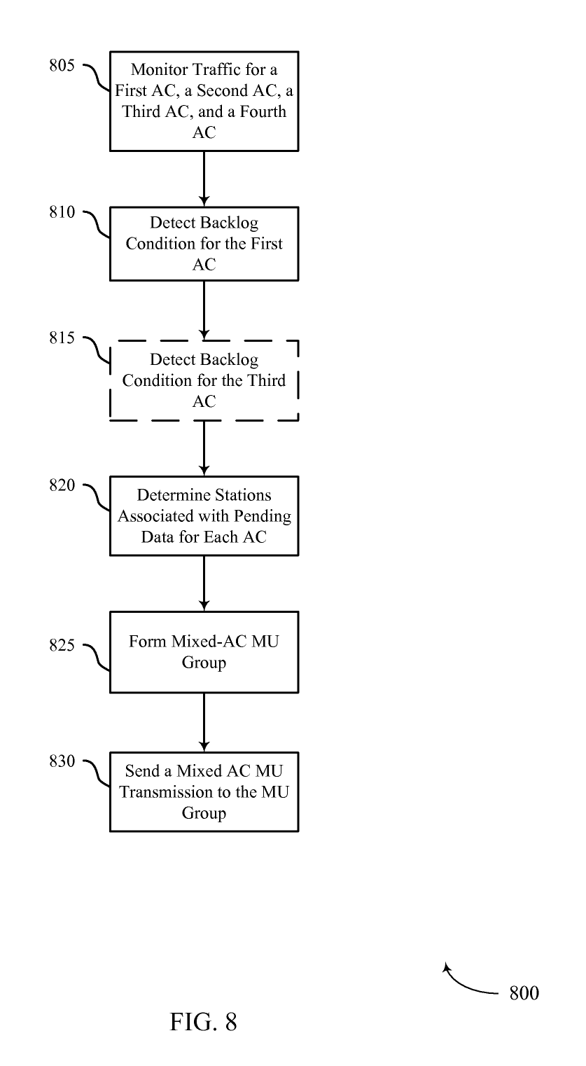

FIG. 8 shows a flow chart that illustrates one example of a method 800 for wireless communication, in accordance with various aspects of the present disclosure. The method 800 may be performed by any of the APs 105 discussed in the present disclosure, but for clarity the method 800 will be described from the perspective of the AP 105-e and AP 105-f of FIGS. 6A and 6B.

Broadly speaking, the method 800 illustrates a procedure by which the AP 105-e or 105-f detects a backlog condition for an AC, forms a mixed-AC MU group based at least in part on the detection, and sends a mixed-AC MU transmission to the mixed-AC MU group.

The method 800 begins with the AP 105-e or AP 105-f operating in a network or BSS. The AP 105-e or AP 105-f supports traffic with different ACs. AP 105-e or AP 105-f also has data of a first AC pending for a primary station. At block 805, the AC backlog detector 625 may monitor traffic for a first AC, a second AC, a third AC, and a fourth AC. The ACs may be voice, video, best-effort, and background. Monitoring may include monitoring the QoS for each AC. In some cases the AC backlog detector monitors the data pending for each AC. At block 810, the AC backlog detector 625 detects a backlog condition for the first AC. The backlog condition may be an accumulation of pending traffic for an AC. In some cases, the AC backlog detector 625 may detect the backlog by determining that the first AC has a QoS that is not satisfied.

At block 815, the AC backlog detector 625 may detect a backlog for the third AC. The detection may be accomplished using any of the techniques described herein. In some cases, the AC backlog detector 625 determines that the backlog for the first AC is greater than the backlog for the third AC. The AC backlog detector 625 may make this determination by comparing the backlog conditions for the respective ACs. At block 820, the MU group selector 605 determines which STAs 110 are associated with the pending data for each AC. Using this information, the MU group selector 605 forms, at block 825, a mixed-AC MU group based at least in part on the detected backlog. For instance, a primary station associated with the fourth AC is selected for the mixed-AC MU group and a partner station associated with a first is paired with the primary station. The partner station is the station associated with the most-underserved AC. The formation of the mixed-AC MU group may also be based at least in part on the stations associated with the backlogged data. At block 830, the MU transmission generator may facilitate the concurrent transmission of pending data of the fourth AC and pending data of the first AC to the mixed-AC MU group.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
forming a multi-user (MU) group comprising a primary station associated with a first modulation and coding scheme (MCS) and a secondary station associated with a second MCS, wherein the second MCS is different from the first MCS;
estimating a throughput for at least one MU transmission configuration from the group consisting of:
a first MU transmission configuration using a common MCS for the primary station and the secondary station at a transmit power corresponding to the common MCS, wherein the common MCS is selected from the group consisting of the first MCS and the second MCS; and
a second MU transmission configuration using the first MCS for the primary station and the second MCS for the secondary station, wherein the primary station and the secondary station use a transmit power corresponding to the second MCS; and
transmitting to the MU group according to one of the MU transmission configurations based at least in part on the estimated throughput for the MU transmission configurations.

2. The method of claim 1, wherein estimating the throughput comprises:
determining that a difference between a first transmit power corresponding to the first MCS and the transmit power corresponding to the second MCS satisfies a threshold; and
wherein transmitting to the MU group comprises selecting the first MU transmission configuration for the transmission based at least in part on the determination.

3. The method of claim 1, wherein estimating the throughput comprises:
determining that a difference between a first transmit power corresponding to the first MCS and the transmit power corresponding to the second MCS does not satisfy a threshold; and
wherein transmitting to the MU group comprises selecting the second MU transmission configuration for the transmission based at least in part on the determination.

4. The method of claim 1, further comprising:
determining channel conditions for a channel associated with the primary station and the secondary station;
wherein estimating the throughput is based at least in part on the channel conditions; and
wherein transmitting to the MU group comprises selecting one of the MU transmission configurations having a highest estimated throughput.

5. The method of claim 4, further comprising:
determining a nominal signal-to-noise ratio (SNR) associated with each of the first MCS and the second MCS, wherein estimating the throughput is based at least in part on the nominal SNRs.

6. The method of claim 1, wherein the common MCS is associated with a highest transmit power between the first transmit power and the second transmit power.

7. The method of claim 1, further comprising:
selecting the first MCS as the common MCS for the first MU transmission configuration if the first MCS is lower than the second MCS.

8. The method of claim 1, further comprising:
selecting the second MCS as the common MCS for the first MU transmission configuration if the first MCS is higher than the second MCS.

9. The method of claim 1, wherein forming the MU group comprising the primary station and the secondary station is based at least in part on a determination that each station in a basic service set (BSS) is associated with a different MCS than the primary station.

10. The method of claim 9, further comprising:
identifying the secondary station as having a highest MCS compared to each station in the BSS that is a candidate for MU grouping with the primary station; and
selecting the secondary station for the MU group with the primary station.

11. The method of claim 1, wherein the transmit power corresponding to the second MCS and a first transmit power corresponding to the first MCS are different.

12. A communication device, comprising:
a multi-user (MU) group selector to form a multi-user (MU) group comprising a primary station associated with a first modulation and coding scheme (MCS) and a secondary station associated with a second MCS, wherein the second MCS is different from the first MCS;
a throughput estimator to estimate a throughput for at least one MU transmission configuration from the group consisting of:
a first MU transmission configuration using a common MCS for the primary station and the secondary station at a transmit power corresponding to the common MCS, wherein the common MCS is selected from the group consisting of the first MCS and the second MCS; and
a second MU transmission configuration using the first MCS for the primary station and the second MCS for the secondary station, wherein the primary station and the secondary station use a transmit power corresponding to the second MCS; and
an MU transmission generator to transmit to the MU group according to one of the MU transmission configurations based at least in part on the estimated throughput for the MU transmission configurations.

13. The communication device of claim 12, wherein the throughput estimator is configured to:
determine that a difference between a first transmit power corresponding to the first MCS and the transmit power corresponding to the second MCS satisfies a threshold; and
wherein transmitting to the MU group comprises selecting the first MU transmission configuration for the transmission based at least in part on the determination.

14. The communication device of claim 12, wherein the throughput estimator is further to:
determine that a difference between a first transmit power corresponding to the first MCS and the transmit power corresponding to the second MCS does not satisfy a threshold; and
wherein transmitting to the MU group comprises selecting the second MU transmission configuration for the transmission based at least in part on the determination.

15. The communication device of claim 12, wherein the throughput estimator is further to:
determine channel conditions for a channel associated with the primary station and the secondary station, wherein estimating the throughput is based at least in part on the channel conditions; and
wherein transmitting to the MU group comprises selecting one of the MU transmission configurations having a highest estimated throughput.

16. The communication device of claim 15, wherein the throughput estimator is further to:
determine a nominal signal-to-noise ratio (SNR) associated with each of the first MCS and the second MCS, wherein estimating the throughput is based at least in part on the nominal SNRs.

17. The communication device of claim 12, wherein the common MCS is associated with a highest transmit power between the first transmit power and the second transmit power.

18. The communication device of claim 12, further comprising:
an MU transmission generator to select the first MCS as the common MCS for the first MU transmission configuration if the first MCS is lower than the second MCS.

19. The communication device of claim 12, further comprising:
an MU transmission generator to select the second MCS as the common MCS for the first MU transmission configuration if the first MCS is higher than the second MCS.

20. The communication device of claim 12, wherein forming the MU group comprising the primary station and the secondary station is based at least in part on a determination that each station in a basic service set (BSS) is associated with a different MCS than the primary station.

21. The communication device of claim 20, further comprising:
an MU group selector to identify the secondary station as having a highest MCS compared to each station in the BSS that is a candidate for MU grouping with the primary station; and
select the secondary station for the MU group with the primary station.

22. The communication device of claim 12, wherein the transmit power corresponding to the second MCS and a first transmit power corresponding to the first MCS are different.

23. A communication device, comprising:
means for forming a multi-user (MU) group comprising a primary station associated with a first modulation and coding scheme (MCS) and a secondary station associated with a second MCS, wherein the second MCS is different from the first MCS;
means for estimating a throughput for at least one MU transmission configuration from the group consisting of:
a first MU transmission configuration using a common MCS for the primary station and the secondary station at a transmit power corresponding to the common MCS, wherein the common MCS is selected from the group consisting of the first MCS and the second MCS; and
a second MU transmission configuration using the first MCS for the primary station and the second MCS for the secondary station, wherein the primary station and the secondary station use a transmit power corresponding to the second MCS; and
means for transmitting to the MU group according to one of the MU transmission configurations based at least in part on the estimated throughput for the MU transmission configurations.

24. The communication device of claim 23, wherein the means for estimating the throughput further comprise:
means for determining that a difference between a first transmit power corresponding to the first MCS and the transmit power corresponding to the second MCS satisfies a threshold; and
wherein transmitting to the MU group comprises selecting the first MU transmission configuration for the transmission based at least in part on the determination.

25. The communication device of claim 23, wherein the means for estimating the throughput further comprise:
means for determining that a difference between a first transmit power corresponding to the first MCS and the transmit power corresponding to the second MCS does not satisfy a threshold; and
wherein transmitting to the MU group comprises selecting the second MU transmission configuration for the transmission based at least in part on the determination.

26. The communication device of claim 23, further comprising:
means for determining channel conditions for a channel associated with the primary station and the secondary station;
wherein estimating the throughput is based at least in part on the channel conditions; and
wherein transmitting to the MU group comprises selecting one of the MU transmission configurations having a highest estimated throughput.

27. A non-transitory computer-readable medium storing code for wireless communication at a wireless device, the code comprising instructions executable to cause a communication device to:
form a multi-user (MU) group comprising a primary station associated with a first modulation and coding scheme (MCS) and a secondary station associated with a second MCS, wherein the second MCS is different from the first MCS;
estimate a throughput for at least one MU transmission configuration from the group consisting of:
a first MU transmission configuration using a common MCS for the primary station and the secondary station at a transmit power corresponding to the common MCS, wherein the common MCS is selected from the group consisting of the first MCS and the second MCS; and
a second MU transmission configuration using the first MCS for the primary station and the second MCS for the secondary station, wherein the primary station and the secondary station use a transmit power corresponding to the second MCS; and
transmit to the MU group according to one of the MU transmission configurations based at least in part on the estimated throughput for the MU transmission configurations.

28. The non-transitory computer-readable medium of claim 27, wherein the instructions are executable to cause the communication device to:
determine that a difference between a first transmit power corresponding to the first MCS and the transmit power corresponding to the second MCS satisfies a threshold; and
wherein transmitting to the MU group comprises selecting the first MU transmission configuration for the transmission based at least in part on the determination.

29. The non-transitory computer-readable medium of claim 27, wherein the instructions are executable to cause the communication device to:
determine that a difference between a first transmit power corresponding to the first MCS and the transmit power corresponding to the second MCS does not satisfy a threshold; and
wherein transmitting to the MU group comprises selecting the second MU transmission configuration for the transmission based at least in part on the determination.

30. The non-transitory computer-readable medium of claim 27, wherein the instructions are executable to cause the communication device to:
determine channel conditions for a channel associated with the primary station and the secondary station;
wherein estimating the throughput is based at least in part on the channel conditions; and
wherein transmitting to the MU group comprises selecting one of the MU transmission configurations having a highest estimated throughput.
